(19) United States
(12) Patent Application Publication
(10) Pub. No.: US 2025/0265606 A1
(43) Pub. Date: Aug. 21, 2025

(54) A SYSTEM AND A METHOD FOR ANALYSING A MARKET OF EXCHANGEABLE ASSETS

(71) Applicant: Kin Kwan Chan, Kowloon Tong (HK)

(72) Inventor: Kin Kwan Chan, Kowloon Tong (HK)

(21) Appl. No.: 18/865,521

(22) PCT Filed: Jun. 28, 2022
(86) PCT No.: PCT/CN2022/101832

§ 371 Date: Nov. 13, 2024

(51) Int. Cl. G06Q 30/0201; G06Q 40/04

(52) U.S. Cl. CPC G06Q 30/0201; G06Q 40/04

(57) ABSTRACT

A system and a method for analysing a market of exchangeable assets. The system comprises a detecting module arranged to detect an event associated with generation and/or transaction of an exchangeable asset; and a processing module arranged to process the detected event to obtain an evaluation score of the market indicating a likelihood of a change of market value of the exchangeable assets; wherein the evaluation score is obtained with reference to a database of a plurality of history events categorized by a plurality of predefined categories and a plurality of seasoned factors according to a plurality of signal classification rules, and wherein the plurality of history events are assigned with the evaluation score.

### TECHNICAL FIELD

The present invention relates to a system and a method for analysing a market of exchangeable assets, and particularly, although not exclusively, to an AI-based crypto market analysis system.

### BACKGROUND

Traders or investors of digital assets or digital currencies may wish to observe actions or trends such as when certain owners of a digital assets or currencies performs a major transaction, so as to predict a market direction. In turn, when such traders or investors are able to observe such events, the trader or investor may proceed with a particular transaction of their digital assets or currencies which they would believe would be the appropriate action given their observations so as to maximize their profits or to minimize their losses.

However, blockchain data is enormous and technically difficult for many traders or investors to extract and interpret. To leverage this issue, some on-chain indicators may be implemented and interpreted in business logic, yet false positives and contradiction in interpreting market atmosphere and certain owner's behaviour may still be high.

### SUMMARY OF THE INVENTION

In accordance with a first aspect of the present invention, there is provided a method for analysing a market of exchangeable assets, comprising the steps of: detecting an event associated with generation and/or transaction of an exchangeable asset; and processing the detected event to obtain an evaluation score of the market indicating a likelihood of a change of market value of the exchangeable assets; wherein the evaluation score is obtained with reference to a database of a plurality of history events categorized by a plurality of predefined categories and a plurality of seasoned factors according to a plurality of signal classification rules, and wherein the plurality of history events are assigned with the evaluation score.

In accordance with the first aspect, the step of processing the detected event includes processing the detected event using an AI-based processing engine, and wherein the database is a database of a training dataset comprising the plurality of history events.

In accordance with the first aspect, the evaluation score is arranged to represent a bullish or a bearish signal of the market of exchangeable assets.

In accordance with the first aspect, the exchangeable asset includes crypto assets.

In accordance with the first aspect, the plurality of predefined categories includes a miner selling event associated with an outflow of crypto assets generated by miners.

In accordance with the first aspect, the plurality of predefined categories includes a whale accumulation/dumping event associated with an accumulation/dumping of crypto assets by institutional investors.

In accordance with the first aspect, the whale accumulation event is represented by a detection of huge over-the-counter deal of the crypto assets on the crypto assets network.

In accordance with the first aspect, the plurality of predefined categories includes a determination of indicators associated with transaction histories of crypto assets in a predetermined period of time, wherein the indicators represent one or more of buying pressure, selling pressure, market trend related to a supply of crypto assets on exchanges and market sentiment.

In accordance with the first aspect, the plurality of signal classification rules includes: using Bollinger Band to detect an outlier; using a tsmoothie function to detect the outlier; or using predefined logics associated with the plurality of seasoned factors each associated with generation and/or transaction of the exchangeable asset, wherein the outlier represents a signal trigger.

In accordance with the first aspect, the method further comprises the step of providing a summary of analysis including the evaluation score of the market, a score calculated for each of the plurality of predefined categories, a score calculated for each of the plurality of seasoned factors, a score indicating past accuracy, a score indicating confidence level and/or a change of real value of each seasoned factor.

In accordance with a second aspect of the present invention, there is provided a system for analysing a market of exchangeable assets, comprising: a detecting module arranged to detect an event associated with generation and/or transaction of an exchangeable asset; and a processing module arranged to process the detected event to obtain an evaluation score of the market indicating a likelihood of a change of market value of the exchangeable assets; wherein the evaluation score is obtained with reference to a database of a plurality of history events categorized by a plurality of predefined categories and a plurality of seasoned factors according to a plurality of signal classification rules, and wherein the plurality of history events are assigned with the evaluation score.

In accordance with the second aspect, the processing module includes an AI-based processing engine, and wherein the database is a database of a training dataset comprising the plurality of history events.

In accordance with the second aspect, the evaluation score is arranged to represent a bullish or a bearish signal of the market of exchangeable assets.

In accordance with the second aspect, the exchangeable asset includes crypto assets.

In accordance with the second aspect, the plurality of predefined categories includes a miner selling event associated with an outflow of crypto assets generated by miners.

In accordance with the second aspect, the plurality of predefined categories includes a whale accumulation/dumping event associated with an accumulation/dumping of crypto assets by institutional investors.

In accordance with the second aspect, the whale accumulation event is represented by a detection of huge over-the-counter deal of the crypto assets on the crypto assets network.

In accordance with the second aspect, the plurality of predefined categories includes a determination of indicators associated with transaction histories of crypto assets in a predetermined period of time, wherein the indicators represent one or more of buying pressure, selling pressure, market trend related to a supply of crypto assets on exchanges and market sentiment.

In accordance with the second aspect, the plurality of signal classification rules includes: using Bollinger Band to detect an outlier; using a tsmoothie function to detect the outlier; or using predefined logics associated with the plurality of seasoned factors each associated with generation and/or transaction of the exchangeable asset, wherein the outlier represents a signal trigger.

In accordance with the second aspect, the system further comprises an output module arranged to generate a summary of analysis including the evaluation score of the market, a score calculated for each of the plurality of predefined categories, a score calculated for each of the plurality of seasoned factors, a score indicating past accuracy, a score indicating confidence level and/or a change of real value of each seasoned factor.

### BRIEF DESCRIPTION OF THE DRAWINGS

Embodiments of the present invention will now be described, by way of example, with reference to the accompanying drawings in which:

FIG. 1 is a schematic diagram of a computer server which is arranged to be implemented as a system for analysing a market of exchangeable assets in accordance with an embodiment of the present invention.

FIG. 2 is a block diagram showing a system for analysing a market of exchangeable assets in accordance with an embodiment of the present invention.

FIG. 3 is a method of training the AI processing engine of the system for analysing a market of exchangeable assets of FIG. 2.

FIGS. 4A to 4C plots showing Bollinger Band for MPI, evolving from raw data plots to final plots showing bearish and bullish indicated by peaks and valleys of the MPI index.

FIGS. 5A to 5C are screen shots showing example user interface of an application showing an analysis results obtained by the system for analysing a market of exchangeable assets of FIG. 2.

### DETAILED DESCRIPTION OF THE PREFERRED EMBODIMENT

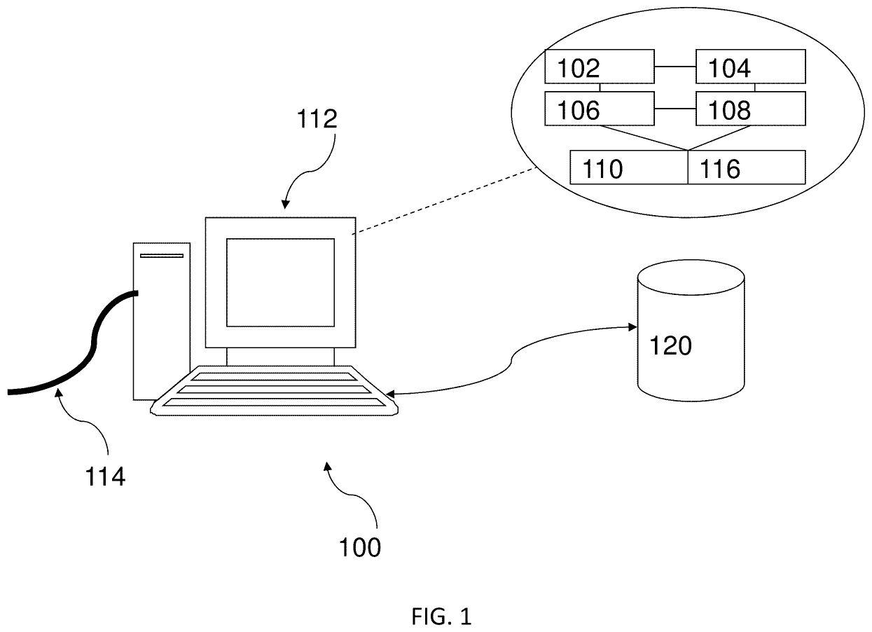

Referring to FIG. 1, an embodiment of the present invention is illustrated. This embodiment is arranged to provide system comprises a detecting module arranged to detect an event associated with generation and/or transaction of an exchangeable asset; and a processing module arranged to process the detected event to obtain an evaluation score of the market indicating a likelihood of a change of market value of the exchangeable assets; wherein the evaluation score is obtained with reference to a database of a plurality of history events categorized by a plurality of predefined categories and a plurality of seasoned factors according to a plurality of signal classification rules, and wherein the plurality of history events are assigned with the evaluation score.

In this example embodiment, the interface and processor are implemented by a computer having an appropriate user interface. The computer may be implemented by any computing architecture, including portable computers, tablet computers, stand-alone Personal Computers (PCs), smart devices, Internet of Things (IOT) devices, edge computing devices, client/server architecture, “dumb” terminal/mainframe architecture, cloud-computing based architecture, or any other appropriate architecture. The computing device may be appropriately programmed to implement the invention.

The system may be used to receive various market data for one or more exchangeable assets which may include digital assets or currencies, including cryptocurrencies and proceed to identify specific events or transactions which may be deemed to be relevant to an expected performance of the exchangeable assets within a defined period after the occurrence of the events or transactions. A machine learning system may be used to process the identified events to provide an output which would reflect the sentiment or trends of the market, such as a bull or bear outlook relating to the exchangeable assets. This machine learning system may also be trained with past data which would exist for any exchangeable asset, including past events or transactions and the performance of the exchangeable asset, and in turn, once trained, the machine learning system, when used with any identified specific events or transactions may provide an output of the market sentiment that may be traced to the specific events or transactions that can explain how the machine learning system has come to this sentiment. This may be advantageous as an accurate market sentiment may be provided, whilst also explainable should a trader or investor wishes to understand how the system has come to the present sentiment outlook, and thus providing more information to a user for more predictable and desirable trading decisions.

As shown in FIG. 1 there is a shown a schematic diagram of a computer system or computer server 100 which is arranged to be implemented as an example embodiment of a system for processing an image stream. In this embodiment the system comprises a server 100 which includes suitable components necessary to receive, store and execute appropriate computer instructions. The components may include a processing unit 102, including Central Processing United (CPUs), Math Co-Processing Unit (Math Processor), Graphic Processing United (GPUs) or Tensor processing united (TPUs) for tensor or multi-dimensional array calculations or manipulation operations, read-only memory (ROM) 104, random access memory (RAM) 106, and input/output devices such as disk drives 108, input devices 110 such as an Ethernet port, a USB port, etc. Display 112 such as a liquid crystal display, a light emitting display or any other suitable display and communications links 114. The server 100 may include instructions that may be included in ROM 104, RAM 106 or disk drives 108 and may be executed by the processing unit 102. There may be provided a plurality of communication links 114 which may variously connect to one or more computing devices such as a server, personal computers, terminals, wireless or handheld computing devices, Internet of Things (IoT) devices, smart devices, edge computing devices. At least one of a plurality of communications link may be connected to an external computing network through a telephone line or other type of communications link.

The server 100 may include storage devices such as a disk drive 108 which may encompass solid state drives, hard disk drives, optical drives, magnetic tape drives or remote or cloud-based storage devices. The server 100 may use a single disk drive or multiple disk drives, or a remote storage service 120. The server 100 may also have a suitable operating system 116 which resides on the disk drive or in the ROM of the server 100.

The computer or computing apparatus may also provide the necessary computational capabilities to operate or to interface with a machine learning network, such as neural networks, to provide various functions and outputs. The neural network may be implemented locally, or it may also be accessible or partially accessible via a server or cloud-based service. The machine learning network may also be untrained, partially trained or fully trained, and/or may also be retrained, adapted or updated over time.

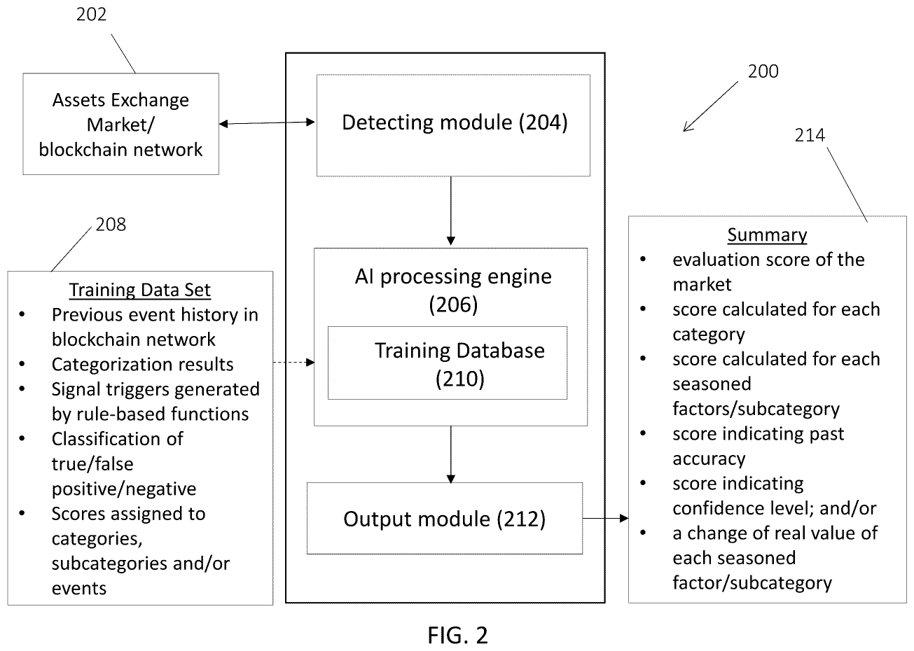

With reference to FIG. 2, there is shown an embodiment of the system 200 for detecting an event associated with generation and/or transaction of an exchangeable asset, such as crypto asset, and more preferably crypto asset which may be exchanged on a blockchain network 202, and for processing the detected event to obtain an evaluation score of the market indicating a likelihood of a change of market value of the exchangeable assets, preferably bullish or bearish of the crypto asset exchange market 202.

In this embodiment, the server 100 is used as part of a system 200, such as a detecting module 204, as arranged to access the database associated with generation and/or transaction of an exchangeable asset, such as a blockchain ledger 202 recording all generation and transaction of crypto asset, and by analysing the data retrieved from the ledger to identify one or more events, such as selling/purchasing of the assets in the exchange market 202, or generating of crypto asset as a results of “cryptocurrency mining” in which newly created “coins” or “tokens” are verified as exchangeable crypto assets which may be sold or transferred.

It should be appreciated that the term “event” may mean a single event such as a buying or selling digital assets, general assets, traditional financial products, commodities, Exchange-Traded Funds (ETFs) in the market or cryptocurrency coins in the exchange market 202, privatising the coins so that it no longer exchangeable on the market, mining the cryptocurrency coins and/or putting the generated coins on the market, etc., or the term “event” may also mean multiple events or a group of events occurring during a predetermined period of time. The event(s) may be detected or interpreted based on data obtained from the blockchain ledger, or from other databases associated with the market of the crypto assets of concern or other assets or other traditional financial products in traditional markets, or in some examples, the events may be detected or interpreted from other databases or data-sources that may be directly or indirectly relevant or associated with the particular asset in concern such as statistics, news, census data, country data, etc.

Similar to other types of exchangeable assets, supplies and demands may cause the market value of the exchangeable assets on the market to increase or decrease, which have associations with how the assets being transferred among buyers/sellers, as well as how the miners process their exchangeable assets in case of cryptocurrencies, e.g. transferring the generated crypto assets registered on the blockchain network to the exchange market so that it become tradable. As at present, it may be observed that there are two types of crypto exchanges in the market, Centralised exchange (CEX) such as Binance & Bybit and Decentralised exchange (DEX) such as Uniswap & Pancakeswap.

As an example, the system may be arranged to trace the whales' and miners' wallet addresses for large amount of “transfer” from the decentralised network to exchange address (such as Binance wallet address (CEX) and Uniswap swapping liquidity pool). In contrast, when the tokens are transferred from a wallet on-chain to centralised exchange is an off-chained action, this may pose potential buying/selling pressure to the crypto market, tokens being transferred to the DEX will be directly traded and exchanged to the market. In this way, it can be observed or theorised that the “buying/selling pressure” occurs only when the tokens are physically transferred out to the exchange wallet. It should be noted that on observations, miner selling is a regular activity since they need to operate their operations with fiat currency, but a great amount of transfer may refer to a cash-out activity.

As appreciated by a person skilled in the art, trading or transaction of a relatively high volume of assets within a short period of time may induce fluctuation of the market price of the assets, and the system in accordance with embodiments of the present invention may predict or identify that the market becoming bullish or bearish as a result of such a fluctuation and/or other events associated with the exchange activities of the market.

For example, when the exchange flow transaction count is high, it implies that the miner transfers Bitcoin to the exchange frequently, or when the exchange flow transaction count is low, it implies that the miner is accumulating and not willing to sell Bitcoin, these “events” may cause fluctuation to the Bitcoin market. It should also be appreciated by a person skilled in art, that since there is a moving threshold, the high/low is only meaningful when the raw value is higher/lower than the usual states of flow. e.g. it may be observed that in the first half of 2022, 10 can be regarded as the local high, when the raw value is higher than 10, there is a higher likelihood to trigger a larger price movement.

In an alternative example, when the index is high, the institutional investor buys Bitcoin in Coinbase with the price premium, or when the index is low, the institutional investor sells Bitcoin in Coinbase. These events may also cause fluctuation to the Bitcoin market, and because of the relative high-volume transaction/accumulation performed by institutional investor, a.k.a “whale” on the market of crypto assets, these events will likely be more influential to fluctuations of the market value of the crypto assets, therefore will more likely causing the market have a likelihood of becoming bullish or bearish.

In yet an alternative example, when the estimated leverage ratio is high, it implies high volatility and liquidity in the derivative market, or when the estimated leverage ratio is low, it implies low volatility and liquidity in the derivative market. These example events may indicate “Market Sentiment” status or phenomenon with reference to also the activity in the derivative market being different from the actual market of the exchangeable asset in concern.

Preferably, the events may be categorized as one or more of the followings, such as but not limited to miner selling, whale accumulation/dumping, huge over-the-counter deal of the crypto asset, buying pressure, selling pressure, market trend related to a supply of crypto assets on exchanges and market sentiment, wherein the categorized events may include different impact on the market value of the crypto assets.

As described earlier, the term “event” may also mean multiple events or a group of events occurring during a predetermined period of time. For example, a “miners' position index” (MPI) maybe determined by calculating a 30-day moving average of total selling from Bitcoin miners, and the MPI may be used in subsequent signal classification steps. In an alternative embodiment, e.g. in events related to whale accumulation, a moving average of 7 days may be sufficient to indicate a possibly huge impact on the market value of the crypto asset, or event a moving average of 24-72 hours may be used to indicate an even more significantly impacting event such as whale dumping, in which a huge exchange inflow may possibly cause a high selling pressure, and therefore a bearish signal may be generated. Alternatively, other duration periods for the moving average may be determined automatically by use of a machine learning or AI system that is arranged to be manually or automatically retrained as necessary for optimizing the accuracy of these calculations.

Referring to FIG. 2, these detected events, or even the raw data which may be interpreted as these events or categorized events are further processed by a processing module, such as an AI-based processing engine 206. The AI-based processing engine 206 may be trained by a database of a training dataset 208 comprising the plurality of history events, such as history transaction events of crypto asset and/or event log extracted from the blockchain ledger in relation to crypto asset mining, executing instructions causing inflow of generated crypto asset into the exchange market and/or moving of the crypto asset out of the exchange market in private wallets.

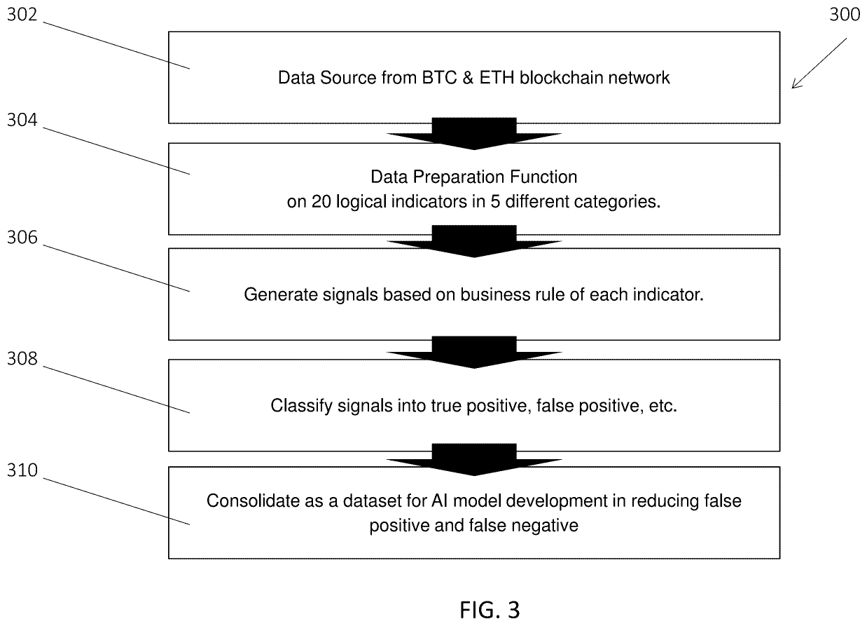

With also reference to FIG. 3, the AI-based processing engine may be trained by performing the following steps. The process 300 starts with step 302, in which data source from BTC & ETH blockchain networks is obtained, then at step 304, data preparation transformation on a predetermined number of logical indicators/seasoned factors in different categories (as described above) is performed. After the preparation step, at step 306, signals/outliers based on business rules or signal classification rules of each indicator may be generated, which indicate “special events” that may significantly impact the market value of the crypto asset. At step 308, the signals may be further classified into true positive, true negative, false positive and false negative, and finally at step 310 these inputs may be further consolidated as an AI training dataset 208 for model development in reducing false positive and false negative, as well as for determination of evaluation score which indicate a likelihood of a change of market value of the exchangeable assets. The developed training database 210 may be stored in, or accessible by the AI processing engine 206.

Preferably, the evaluation score may be obtained by consolidating the individual scores of the categorized events and/or the logical indicators/seasoned factors, with or without weights/factors applied to each of these categorized events. For example, the evaluation score may be an accumulated weighted score of all seasoned factors in a range of −10 to +10 representing respectively a bearish signal and a bullish signal caused by events of that category/factor, and the final evaluation score may also be in the range of −10 to +10 representing respectively a strong bearish signal and a strong bullish signal.

After the AI processing engine has been trained with the database of “manually scored/evaluated” history events categorized by a plurality of predefined categories and a plurality of seasoned factors according to a plurality of signal classification rules, the AI processing engine is ready for processing new data/events obtained from the exchange market (including derivative markets) and/or blockchain network. In one example embodiment, the AI processing engine may include an automated machine learning (AutoML) AI processing engine. It should be appreciated that the AI processing engine may be implemented using other AI or machine learning technologies.

In addition, referring to FIG. 2, the system further comprises an output module 212 arranged to generate a summary 214 of analysis including the evaluation score of the market, a score calculated for each of the plurality of predefined categories, a score calculated for each of the plurality of seasoned factors, a score indicating past accuracy, a score indicating confidence level (i.e. how confident the result will be valid) and/or a change of real value of each seasoned factor (e.g. High, 100,000 USDT transferred).

As describe earlier, the events may be categorized into different categories and/or subcategories (or sometimes called seasoned factors). For example, the seasoned factors may be categorized into 7 major categories, including: Miner Selling, Whale Accumulation, Huge OTC deal, Buying/Selling Pressure, Market Trend, Market Sentiment and Whale Dumping. These categories may pose different impacts to the market value of the crypto market.

For example, the market value of various digital assets may be significantly affected by miner selling events. Miners, who are in the process of using vast amount of computing power to generate or “mint” new digital assets may have hold a significant amount of digital assets as part of their operation and are referred to as OG whales or whales. In this sense, it is their common practice to periodically send a certain amount of digital assets such as Bitcoins or (BTC) to exchanges since they would need fiat currency to cover their ordinary operation expenses. However, if they decided to sell more of such digital assets or coins, or if they sell a significant amount of their assets within a short period of time, then their outflow is likely to be changed significantly. In turn, this may indicate a cash-out activity.

Certain example indicators in the miner selling categories are explained as examples with respect to certain digital assets such as Bitcoin or Coinbase. It would be appreciated that such indicators which may be observed, retrieved or obtained from various data sources through the inventor's research, reviews, tests and trials are not exhaustive and may vary, changed or adjusted to operate with the system as based on overall developments, performance and changes in the market. These examples, without limitations include the following:

BTC: All Miners to All Exchanges Flows Transactions Count is an indicator which may indicate the frequency of all miners wanting to transfer their digital assets (e.g. BTC or Bitcoin) to exchanges. This indicator, if at a low level may indicate that the miners are simply selling a certain amount of digital assets to an exchange to obtain fiat currency to sustain their operations. However, at certain high levels, the indicator may indicate that the miners have taken a bearish outlook if the indicator reflects that miners are selling their digital assets to exchanges more frequently or in high volumes as this may reflect a situation where the miners are selling their digital currencies (bitcoin) on the exchange and not through the OTC market.

BTC: All Miners' Outflows is an indicator which reflects the total transferred amount from mining wallets that have received a digital asset (e.g. Blockchain) block reward. Miners may periodically send digital asset to other wallets as part of their operation or adjustment, but if the price of the digital asset is considered high (e.g. overvalued), the miners may sell the digital asset to the over-the-counter (OTC) market or exchanges. Accordingly, if the indicator indicates that there is a significant miner outflow, then this could be an indication of a bearish outlook or signal.

BTC: Miners' Position Index (MPI: 30-day MA) is determined by the “All miners' outflow” divided by a one-year moving average. This index could therefore provide an indication of when miners withdraw an unusually large amount of digital asset (e.g. Bitcoins) compared to previous years. In situations where the MPI increases, the indication is that the miners are selling more this year than in previous years (or any other period as can be adjusted) and thus this may be an indication that the digital asset price is likely to take on a bearish outlook. Similarly, the MPI may also be decreased and this in turn may indicate that miners are selling less, and therefore may be an indication that they will have a more bullish outlook.

Alternatively, Miners' Position Index (MPI) may also be defined as the ratio of the number of all miners' outflows in USD divided by a predefined period (90 days, 180 days or 365 days moving average.

A benefit of the Miners' Position Index (MPI) is that the MPI may include the average behavior of all major miners into account by using a period of moving averages. This is an advantage over the miner outflows indicator mentioned above as the index may be more inclusive of a plurality of miner's behaviours. Additionally, the MPI indicator may also be used to explain a relative miner's liquidation behaviour compared with historical averages and thus based on the assumption that the miner is operating efficiently, this index may also be a reflection of suitable times for exiting the market and thus may be used to replicate a miner's behaviour.

The second category is to consider the indicators relating to Whale Accumulation. Whales, entities or individuals that holds a large amount of a digital asset, may be able to manipulate the digital asset market due to their size of holdings or their influence in the market. When whales accumulate an asset, such as digital assets e.g. Bitcoins, the outlook is likely to be seen as bullish as it may also indicate that whales/miners are positive for the growth of the digital asset (e.g. Bitcoin), thus such an event may indicate a bullish signal that attracts more capital inflow into the digital asset market.

BTC: Coinbase Premium Index is the price difference between a digital asset and the price in which one would pay for it via an exchange. As an example, Coinbase, which is an exchange for cryptocurrencies or digital assets has a Coinbase's BTCUSD pair whilst Binance which is another exchange has a Binance's BTCUSDT pair. The higher this premium may be would indicate that Coinbase or Binance whales accumulate another digital asset despite the high premiums, and thus may indicate that there is a bullish outlook in the market.

It is observed that Whales may tend to realize profits when retail investors are active in the market, so BTC: All Exchanges Inflow Mean (7-day MA) may be used as an indicator which is the 7-day moving average on the All Exchanges Inflow Mean. Bitcoin price may be an indication that the price will go up when whales are active in the market over the long term. When this indicator goes below 1 BTC, it may be an indicator that retail investors are involved, and thus this may indicate a bearish outlook.

Alternatively, detecting Huge OTC (Over-the-counter) deal may be another way of detecting whale accumulation. In this category, BTC: Fund Flow Ratio & Tokens Transferred are the key indicators, in which Tokens Transferred refers to the total amount of Bitcoin that may have moved on to the network. Fund Flow Ratio is the amount of Bitcoin used for deposits/withdrawals on the exchange divided by tokens transferred, where high values mean investors are actively using the exchange and low values mean investors are using the exchanges in low rates.

In this category, if the Tokens Transferred is high, and the Fund Flow Ratio is low, this combination may be an indication that OTC transactions are active. In turn, this may be an indication that there may be more whale accumulation taking place as whales are likely to buy much of a digital asset unannounced, and away from exchanges, such as by OTC transactions.

This has been observed in the past, including in 2020 when the Bitcoin price was around $10K mark. It was observed at the time when transaction records were studied that 4 million or $40B worth of Bitcoin was moved onto the network, but only 3% of these transactions took place through an exchange. This would mean the difference of 97% took place outside of the exchange, and likely via the OTC market. The results of this event were that many large Bitcoin holders subsequently announced that they had acquired Bitcoin after the transactions were completed.

Another major category is Buying/Selling Pressure, in particular On-chain indicators may suggest potential Bitcoin buying/selling pressure.

For example, with respect to Stablecoins: All Exchanges Inflow Addresses Count is a measure of the number of deposit wallets in all types of stablecoins flowing into all exchanges by block. If this indicator goes above a certain threshold, then this may be an indicator that the price will likely be a short-term bullish outlook as there is a large amount of stablecoins being deposited consecutively within a short amount of time.

As measured on a per ETH block interval, since each block interval is around 10 to 15 seconds, if a certain threshold of stablecoins is deposited within this time interval, and this occur on a number of occasions, then this would indicate that there is a short-term bullish outlook on the stablecoin.

Alternatively, BTC: Stablecoin Ratio in USD (MACD) may be an indicator which indicates Bitcoin holdings in USD of all exchanges divided by stable coin holdings. It helps to see the potential selling pressure by looking at relative power between Bitcoin and stablecoins reserve.

The Bitcoin supply held by exchanges may also be used for determining the bullish/bearish market trend for Bitcoin. As an example, an indicator of BTC: All Exchanges Reserve may be considered.

Exchange reserve is a collective measure of potential digital assets or coins that are ready to be sold in the market. Exchange Reserve may therefore be determined by the exchange In/Outflow, and in turn, calculating the Netflow of an exchange. If there is a trend of increasing Netflow, then this may indicate that there is selling pressure whilst a decreasing trend may indicate the buying pressure of a particular digital asset or coin. Furthermore, if the Exchange In/Outflow and Netflow is reviewed over a specific period or interval, it is possible to also track the Exchange Reserve based on the movement of its reserved as measured by its in/outflow. In turn, this can reflect the level of (high or low) buying or selling pressure in the exchange.

When considering this indicator, Exchange In/Outflow & Netflow may be defined in which exchange inflow is defined as an amount of coin deposited into the exchange wallets and exchange outflow is defined as an amount of coin withdrawal from the exchange wallets.

High selling pressure-A large number of coins are staying in the exchange to be traded indicating high selling pressure; or Low selling pressure.

By examining trend, the changing status in scarcity may be shown:
Increasing trend: This may mean that more digital assets or coins are available in the exchange. In turn, an increase in amount of digital assets for trading within the exchange would indicate decreasing scarcity of the digital asset. This would therefore be indicative of a bearish outlook;
Decreasing trend: This is the opposite of increasing trend and thus it would mean there are less digital assets or coins available in the exchange, and thus increasing the digital assets scarcity. This would be indicative of a bullish outlook.

Alternatively, BTC: All Exchanges Netflow (30-day MA) may also be used to indicate the differences between exchange inflow and outflow. In a bull market, Netflow is observed to likely to keep negative (more coins being held by the exchange). Similarly, in a bear market, the Netflow is likely to be positive meaning as the exchange holds less coins (more out than in).

In the Market Sentiment category, indicators may also be used to evaluate the subjective views or thoughts of investors. For example, an indicator may include:
BTC: Aggregated Funding Rate/Futures Open Interest for All Exchanges. In this example, if futures open interest for all exchanges increases it is likely to indicate that a major or significant event such as a cascading liquidation may happen. Alternatively, Open interest may also be considered and is defined as the amount of open positions (including both long and short positions) currently on a derivative exchange's BTC/USD trading pairs.

A large value of open interest may indicate increased price volatility of a digital currency. For this reason, an open interest chart may be used to detect the market tops and bottoms with additional indicators. As an example: “Increasing” may include Adding liquidity, volatility, and attention and supporting ongoing price trend. As positions and contracts are continuously being opened, it indicates more liquidity, volatility, and attention are coming into the derivative market. Increasing trend in OI could support the current ongoing price trend; and “Decreasing” may include Exiting liquidity, volatility, and attention, as Open Interest (OI) decrease, it indicates futures contract/positions are being closed. In turn, this might trigger the possibility of long/short squeeze caused by sudden price movement or vice versa.

In Correlation Analysis to Volatility, the analysis has indicated that open interest (independent variable) and volatility (response variable) may be positively correlated.

Funding rates may be periodic payments made between traders so as to make the perpetual futures contract price as close as possible to the index price. Funding rates may also make the perpetual futures contract price as close as possible to the index price. It is made to be closer to the spot prices and cover some of the gap generated by the perpetual period of time. All cryptocurrency derivatives exchanges use funding rates for perpetual contracts and the standard unit is a percentage.

Funding rates may represent traders' sentiments in the perpetual swaps market and the amount is proportional to the number of contracts.

If rates are over ‘0’ (Positive rates): This may indicate a Dominant Long Sentiment. In this example, a positive funding rate may indicate that long position traders are dominant and are willing to pay short traders. This in turn may be an indication that many traders are bullish.

If rates are under ‘0’ (Negative rates): Dominant Short Sentiment. This would have the opposite effect of Positive Rates as mentioned above. Negative funding rates indicate that short position traders are dominant and are willing to pay long traders. This in turn may be an indication that many traders are bearish.

Another indicator may include BTC: Estimated Leverage Ratio for all exchanges. This indicator can be obtained by dividing the open interest of exchange by their BTC reserve. In turn, it is then possible to estimate relative average user leverage. When this leverage value reaches a high value, it may indicate that there is rapid volatility in the market. This is similar to the Open Interest indicator, but also includes the growth factor of the exchange itself, and is likely to be more reliable.

By examining trends, it may be able to show or demonstrate the sentiment or tendency of total investors' desires to use leverage. For example, an increasing trend may indicate “Holding More Leverage”, as an increase in values may indicate there is a majority of investors who are willing to take high leverage risk in the derivatives trade. Additionally, if ELR values are higher when compared to the last couple of days, this may also suggest that traders are confident in their positions. On the other hand, a decreasing trend may indicate “Taking off Leverage”, as an decrease in values may indicate that there is a majority of investors who are willing to reduce leverage risk in the derivatives trade.

Yet another example category is whale dumping, which may indicate significant bitcoin deposits from whales usually indicate whale dumping.

For example, BTC: All Exchanges Inflow Mean (24 h MA) is the average amount of bitcoin deposited into all exchanges. User of the system may utilize this indicator with a pre-defined interval moving average such as a (24-hour moving average) with each block being approximately 10 minutes, or 144 blocks. By studying this indicator over a 24 hour period, if this indicator goes over a certain threshold during a surge, then it may be that there is a whale dumping in progress. If it goes below a certain threshold immediately after a dip, it may suggest that victim whales are depositing to exchanges but have not yet sold the digital asset or coins.

In an alternative example, BTC: Exchange Whale Ratio (72 h MA) may be considered. The exchange Whale Ratio is the relative size of the top 10 inflow transactions to total inflows. Previous observations have indicated that in a bull market, this exchange whale ration maintains a level of below 85%. Similarly, in a bear market or fake bull market, there may be mass sales or dumping in which case, the exchange whale ration may maintain a level of above 85%.

Alternatively, one way in which the Exchange Whale Ratio may be determined is by obtaining the total BTC amount of top 10 transactions (in terms of total BTC sent) and dividing the total by the total BTC amount flowing into exchange. In turn, once the Whale Focused Exchanges with the top ten Inflows are identified, one can look at the relative size of the top 10 inflows to the total inflows to discover which exchanges whales prefer to use. In turn, this information may be a precursor to for large price volatility and may give rise to risks and arbitrage.

It is appreciated by a skilled person that the categories and/or seasoned factors may be redefined according to changes in the crypto market, such as the scale of the crypto market, the characteristics/attributes of different crypto assets, and the investors' preferences and practices in trading in different crypto markets or platforms.

Preferably, the plurality of signal classification rules includes: using Bollinger Band to detect an outlier; using a tsmoothie function to detect the outlier; or using predefined logics associated with the plurality of seasoned factors each associated with generation and/or transaction of the exchangeable asset; wherein the outlier represents a signal trigger.

For example, using Bollinger Band to detect outlier may be performed by moving average 7 and 1 SD for the upper boundary and lower boundary, and detecting any outlier exceeding the upper boundary and lower boundary, based on the signal classification rule as follows:

“when indicator value >= upper boundary, bearish
when indicator value < upper boundary value and > lower boundary,
neutral
when indicator value <=lower boundary value, bullish”

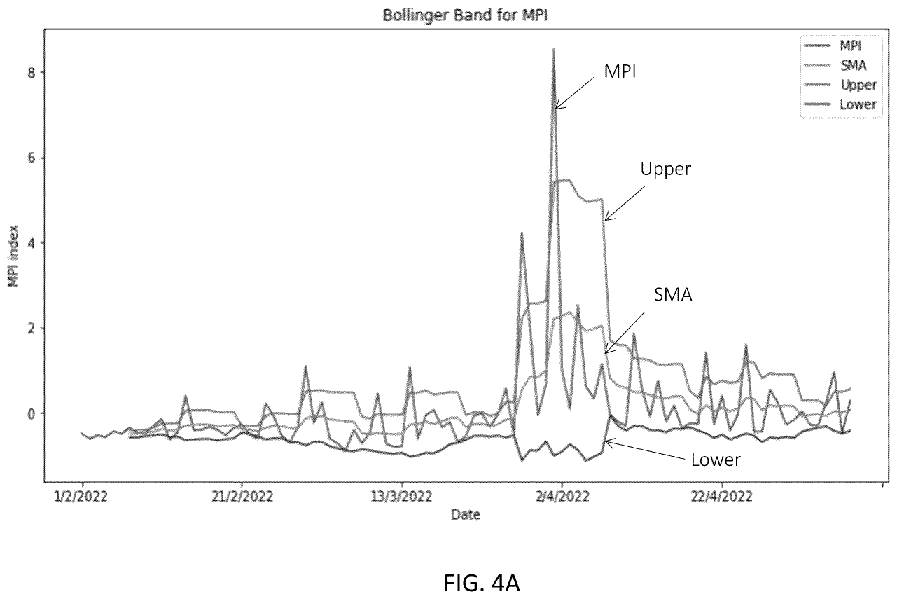

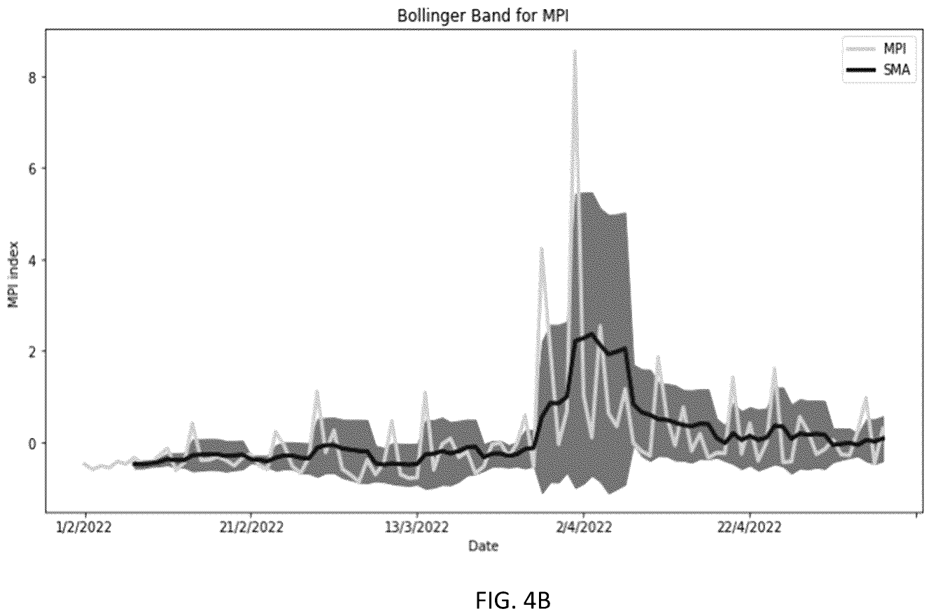

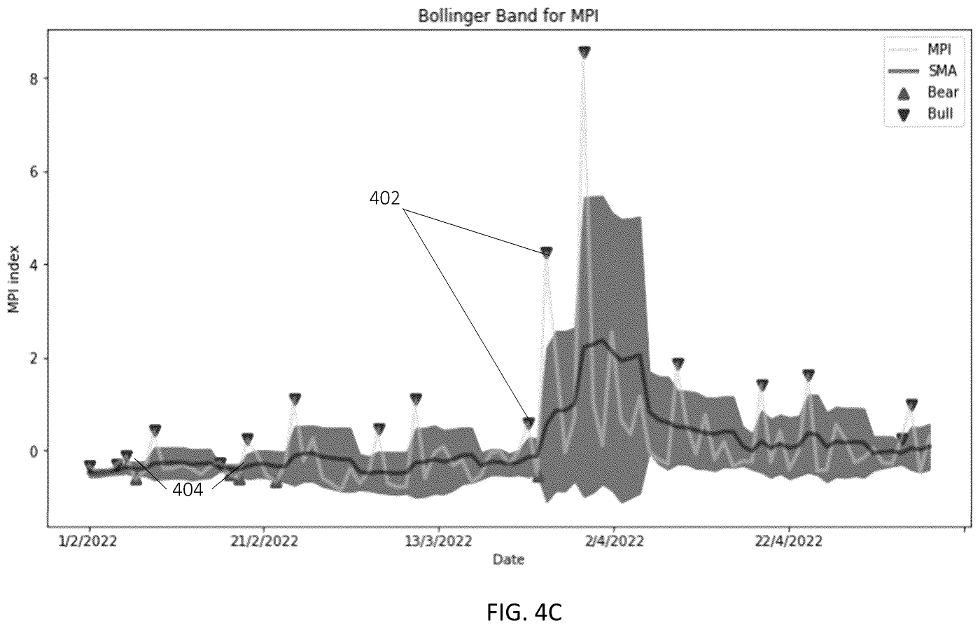

With reference to FIG. 4A to 4C, there is shown an example illustration of the data model and analytics flow. Firstly, the library and data may be imported, and then the Bollinger Band may be plotted, referring to FIG. 4A, in which the plots of the calculated MPI, highest and lowest market values of the crypto assets, as well as the moving average as described earlier. The AI processing engine may automatically process the detected event to obtain an evaluation score of the market indicating a likelihood of a change of market value of the exchangeable assets, for example, identifying multiple peaks 402 and valleys 404 as shown in FIGS. 4B and 4C, which may respectively indicate bullish and bearish of the market on these dates.

Alternatively, the plurality of signal classification rules includes using a tsmoothie function to detect the outlier, based on the following relationship:

“when indicator value >= upper boundary, bearish
when indicator value < upper boundary value and > lower boundary,
neutral
when indicator value <=lower boundary value, bullish”

Yet alternatively, the plurality of signal classification rules includes using other predefined logics associated with the plurality of seasoned factors each associated with generation and/or transaction of the exchangeable asset, e.g. based on the following relationship:

“when indicator value >= 0, bearish
when indicator value <0 & <−1, neutral
when indicator value <= −1, bullish”

Similarly, for other seasoned factors or categorized events, outliers or signal triggers indicating bearish or bullish signal may be obtained by one of these three different approaches, or multiple approaches for verification purpose.

In an alternative example, taking Huge OTC deal determination as example, when considering the “BTC: Fund Flow Ratio & Tokens Transferred” indicator, the outliners/triggers may be determined by:

“when indicator value >= upper boundary value, High
when indicator value < upper boundary value & > lower boundary, Low
when indicator value <= lower boundary value, Low”

when using Bollinger Band method or the tsmoothie function method, or determined by:

“when indicator value >= 0.03, High
when indicator value < 0.03 & > 0.008, Low
when indicator value <= 0.008, Low”

when using the logical function method. Accordingly, if the fund flow ratio is low and the token transferred is high, it means that the whale is transferring and buying the bitcoin through OTC but not through the exchange, so in turn, the market may be indicated as being bullish. If the fund flow ratio is high and the token transferred is high, it means that the whale is transferring and buying the bitcoin through an exchange, the market may also be considered bullish. However, if the fund flow ratio is low and the token transferred is low, it may mean that there are not much trading volume and buying or selling pressure on both exchange and OTC, thus the market is bearish or neutral.

In some alternative embodiments, different methods or functions may be used to identify outliers or anomalies and thus are not limited to using the Bollinger Band method or the tsmoothie function method. Other functions or methods may consider when certain indicator values meet or exceed a certain threshold and in turn, determine if there is a possible outlier or anomaly.

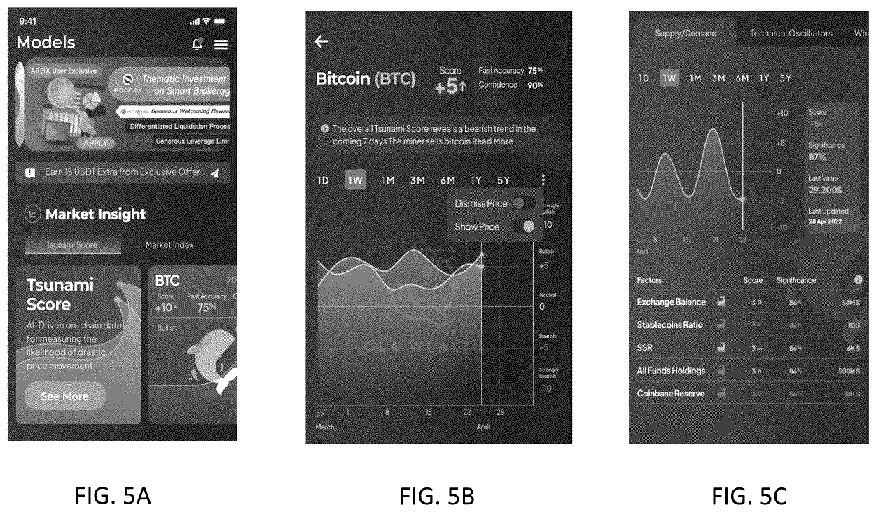

With reference to FIGS. 5A to 5C, there is shown example screenshots of a software application arranged to display or present the information related to the cryptocurrency market. In this example, the evaluation score of the previous embodiment is represented as “Tsunami score” that indicate “bearish” or “bullish” likelihood. Referring to FIG. 5B, there is shown a variation of the tsunami score in the range of −10 (strongly bearish) to +10 (strongly bullish), in which −5 represents bearish, +5 represents bullish, and 0 represent neutral.

As described earlier, the output module 212 may also generate a summary 214 including individual scores of each category/seasoned factor, for example, Exchange Balance, Stablecoins Ratio, SSR, All Funds Holdings and Coinbase Reserve. The table also shows a significant of each of the factors for better understanding of the crypto market.

These embodiments may be advantageous in that, the system provide a qualitative analysis for customer to understand the crypto market. Advantageously, Accordingly, the system may be used to look for the observable trends of the crypto market and decide on whether it is bullish or bearish, and is able to explain that result based on scores within the different categories.

Advantageously, end users can see the scores in the summary and therefore make the AI human explainable. In addition, the system utilities the characteristics of the blockchain ledger to provide as much information as possible to the end users, since it is possible due to AML and KYC requirements that exchanges will have identification of customers, one can look at the public blockchain (ledger) and decide work out if certain whales or miners are buying up lots or dumping a lot of cryptos assets.

For example, the system may notify users for drastic and significant movement triggered by whales, miners, and institutions. The system may also interpret and describe the situation in human-understandable summary. The system also provides a back tested and quantitative method to digest the significant factors which can provide actionable insights for decision making, as well as a fair indicator that quantifies market sentiment based on the user's action.

In an alternative example, the system may serve as a fair measurement that provides historical data and back tested results for user reference to understand the market sentiment, risk level and trend. In addition, as a key fundamental methodology to analyze on-chain indicators and behavioral data, it can be a representative economic indicator for other data scientist and analyst to study the correlation with the off-chain financial market and economy.

Although not required, the embodiments described with reference to the Figures can be implemented as an application programming interface (API) or as a series of libraries for use by a developer or can be included within another software application, such as a terminal or personal computer operating system or a portable computing device operating system. Generally, as program modules include routines, programs, objects, components and data files assisting in the performance of particular functions, the skilled person will understand that the functionality of the software application may be distributed across a number of routines, objects or components to achieve the same functionality desired herein.

It will also be appreciated that where the methods and systems of the present invention are either wholly implemented by computing system or partly implemented by computing systems then any appropriate computing system architecture may be utilised. This will include tablet computers, wearable devices, smart phones, Internet of Things (IoT) devices, edge computing devices, stand-alone computers, network computers, cloud-based computing devices and dedicated hardware devices. Where the terms “computing system” and “computing device” are used, these terms are intended to cover any appropriate arrangement of computer hardware capable of implementing the function described.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

1. A system for analysing a market of exchangeable assets, comprising:
a detecting module arranged to detect an event associated with generation and/or transaction of an exchangeable asset; and
a processing module arranged to process the detected event to obtain an evaluation score of the market indicating a likelihood of a change of market value of the exchangeable assets;
wherein the evaluation score is obtained with reference to a database of a plurality of history events categorized by a plurality of predefined categories and a plurality of seasoned factors according to a plurality of signal classification rules, and wherein the plurality of history events are assigned with the evaluation score.

2. The system of claim 1, wherein the processing module includes an AI-based processing engine, and wherein the database is a database of a training dataset comprising the plurality of history events.

3. The system of claim 1, wherein the evaluation score is arranged to represent a bullish or a bearish signal of the market of exchangeable assets.

4. The system of claim 1, wherein the exchangeable asset includes crypto assets.

5. The system of claim 4, wherein the plurality of predefined categories includes a miner selling event associated with an outflow of crypto assets generated by miners.

6. The system of claim 4, wherein the plurality of predefined categories includes a whale accumulation/dumping event associated with an accumulation/dumping of crypto assets by institutional investors.

7. The system of claim 6, wherein the whale accumulation event is represented by a detection of huge over-the-counter deal of the crypto assets on the crypto assets network.

8. The system of claim 4, wherein the plurality of predefined categories includes a determination of indicators associated with transaction histories of crypto assets in a predetermined period of time, wherein the indicators represent one or more of buying pressure, selling pressure, market trend related to a supply of crypto assets on exchanges and market sentiment.

9. The system of claim 1, wherein the plurality of signal classification rules includes:
using Bollinger Band to detect an outlier;
using a tsmoothie function to detect the outlier; or
using predefined logics associated with the plurality of seasoned factors each associated with generation and/or transaction of the exchangeable asset;
wherein the outlier represents a signal trigger.

10. The system of claim 1, further comprising an output module arranged to generate a summary of analysis including the evaluation score of the market, a score calculated for each of the plurality of predefined categories, a score calculated for each of the plurality of seasoned factors, a score indicating past accuracy, a score indicating confidence level and/or a change of real value of each seasoned factor.

11. A method for analysing a market of exchangeable assets, comprising the steps of:
detecting an event associated with generation and/or transaction of an exchangeable asset; and
processing the detected event to obtain an evaluation score of the market indicating a likelihood of a change of market value of the exchangeable assets;
wherein the evaluation score is obtained with reference to a database of a plurality of history events categorized by a plurality of predefined categories and a plurality of seasoned factors according to a plurality of signal classification rules, and wherein the plurality of history events are assigned with the evaluation score.

12. The method of claim 11, wherein the step of processing the detected event includes processing the detected event using an AI-based processing engine, and wherein the database is a database of a training dataset comprising the plurality of history events.

13. The method of claim 11, wherein the evaluation score is arranged to represent a bullish or a bearish signal of the market of exchangeable assets.

14. The method of claim 11, wherein the exchangeable asset includes crypto assets.

15. The method of claim 14, wherein the plurality of predefined categories includes a miner selling event associated with an outflow of crypto assets generated by miners.

16. The method of claim 14, wherein the plurality of predefined categories includes a whale accumulation/dumping event associated with an accumulation/dumping of crypto assets by institutional investors.

17. The method of claim 16, wherein the whale accumulation event is represented a detection of huge over-the-counter deal of the crypto assets on the crypto assets network.

18. The method of claim 14, wherein the plurality of predefined categories includes a determination of indicators associated with transaction histories of crypto assets in a predetermined period of time, wherein the indicators represent one or more of buying pressure, selling pressure, market trend related to a supply of crypto assets on exchanges and market sentiment.

19. The method of claim 11, wherein the plurality of signal classification rules includes:
using Bollinger Band to detect an outlier;
using a tsmoothie function to detect the outlier; or
using predefined logics associated with the plurality of seasoned factors each associated with generation and/or transaction of the exchangeable asset;
wherein the outlier represents a signal trigger.

20. The method of claim 11, further comprising the step of providing a summary of analysis including the evaluation score of the market, a score calculated for each of the plurality of predefined categories, a score calculated for each of the plurality of seasoned factors, a score indicating past accuracy, a score indicating confidence level and/or a change of real value of each seasoned factor.
